(19) United States
(12) Patent Application Publication
(10) Pub. No.: US 2016/0119358 A1
(43) Pub. Date: Apr. 28, 2016

(54) TECHNIQUES FOR MANAGING ACCESS TO HARDWARE RESOURCES ON MULTIPLE-PERSONA MOBILE TECHNOLOGY PLATFORMS

(71) Applicant: Cellrox, Ltd., Tel Aviv (IL)

(72) Inventors: Oren LAADAN, New York, NY (US); Amir GOLDSTEIN, Tel Aviv (IL); Micha KALFON, Tel Aviv (IL)

(73) Assignee: Cellrox, Ltd., Tel Aviv (IL)

(21) Appl. No.: 14/924,645

(22) Filed: Oct. 27, 2015

Related U.S. Application Data
(60) Provisional application No. 62/068,783, filed on Oct. 27, 2014.

(51) Int. Cl. H04L 29/06; H04L 29/08; G06F 21/62; H04W 12/08

(52) U.S. Cl. CPC H04L 63/102; H04W 12/08; H04L 67/306; G06F 21/6218

(57) ABSTRACT

Techniques for managing access to hardware resources on a multiple-persona mobile technology platform (MTP). The method comprises: detecting an access event between at least one persona and at least one hardware resource of the MTP; identifying at least one access control of the at least one persona; determining for each persona, based on the at least one access control, whether the persona has permission to access the at least one hardware resource; and upon determining that at least one permitted persona has permission to access the at least one hardware resource, granting the access to the at least one permitted persona.

### CROSS-REFERENCE TO RELATED APPLICATIONS

This application claims the benefit of U.S. Provisional Application No. 62/068,783 filed on Oct. 27, 2014, the contents of which are hereby incorporated by reference.

### TECHNICAL FIELD

The present disclosure relates generally to multiple-persona mobile technology platforms (MTPs), and more specifically to techniques for managing access to hardware resources of MTPs respective of different personas.

### BACKGROUND

In modern mobile technology, a computing device may be assigned with personas. Each persona represents an identity or role for a user of the computing device and may be associated with a unique set of access restrictions regarding various hardware resources (e.g., peripherals of the computing device) accessible to the persona.

Existing solutions for executing multiple personas on a computing device typically include running at most one persona in an active “foreground” mode and running the remaining personas in an inactive “background” mode. The access to hardware resources of the computing device) applied to the computing device at any given time are controlled by the foreground persona. The background personas, although not affecting the access restrictions, remain running in the background rather than in a sleeping or otherwise suspended mode. Such background personas may continue to access hardware resources subject to the access restrictions of the foreground personas.

Existing solutions for executing personas in the foreground and background of computing devices are limited in that the access restrictions applicable to the foreground personas are also applied uniformly among all personas. As a result, a background persona wishing to access hardware resources that are not accessible to the current foreground persona(s) must switch to the foreground in order to obtain access. For example, running a “work” persona that is not permitted to receive phone calls in the foreground of a computing device would prevent any persona running in the background from receiving phone calls. Therefore, to allow a persona running in the background to access a resource restricted by a persona running in the foreground, there is a need to switch between the personas.

That is, the problem with the foreground/background model is that all means for users' interaction with the device are tied to a single foreground persona. Therefore, a problem may arise when it is necessary to allocate different peripherals to different personas. This impedes personas, specifically personas running in the background from implementing full functionality.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for managing access to hardware resources on a multiple-persona mobile technology platform (MTP). The method comprises: detecting an access event between at least one persona and at least one hardware resource of the MTP; identifying at least one access control of the at least one persona; determining for each persona, based on the at least one access control, whether the persona has permission to access the at least one hardware resource; and upon determining that at least one permitted persona has permission to access the at least one hardware resource, granting the access to the at least one permitted persona.

The disclosed embodiments also include a multiple-persona mobile technology platform (MTP) for managing access to hardware resources on multiple-persona mobile technology platforms, comprising: a processing unit; and a memory, the memory containing instructions that, when executed by the processing unit, configure the system to: detect an access event between at least one persona and at least one hardware resource of the MTP; identify at least one access control of the at least one persona; determine for each persona, based on the at least one access control, whether the persona has permission to access the at least one hardware resource; and upon determining that at least one permitted persona has permission to access the at least one hardware resource, grant the access to the at least one permitted persona.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a multiple-persona mobile technology platform according to an embodiment.

FIG. 2 is a flowchart illustrating a method for granting private or exclusive access to a portion of a hardware resource to a persona of a multiple-persona mobile technology platform according to an embodiment.

FIG. 3 is a flowchart illustrating a method for granting shared access to a portion of a hardware resource to two or more personas of a multiple-persona mobile technology platform according to an embodiment.

FIG. 4 is a flowchart illustrating a method for granting temporary access to a portion of a hardware resource to one or more personas of a multiple-persona mobile technology platform according to an embodiment.

FIG. 5 is a flowchart illustrating a method for managing access of personas to hardware resources according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a multiple-persona mobile technology platform (MTP) and methods for managing persona access to hardware resources on MTPs. An access event is detected. The access event may be, but is not limited to, an attempt by a persona to access hardware resources, an attempt by a hardware resource to deliver content to personas, and/or a switch from the foreground to the background by an accessing persona. Upon detecting the access event, it is determined whether access controls of each of the personas permits the persona to access the hardware resources. For each persona, if the persona is permitted to access the hardware resources, a type of access is determined based on the context of the access event. Based on each determined type of access, each respective persona is granted access to the hardware resources.

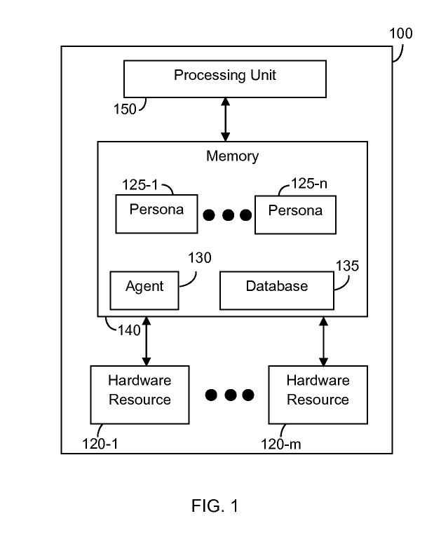

FIG. 1 shows an exemplary and non-limiting schematic diagram of a multiple-persona mobile technology platform (MTP) 100 utilized to describe the various disclosed embodiments. The MTP 100 may be communicatively connected to a network through a network interface. The network may be a local area network (LAN), a system area network (SAN), a wide area network (WAN), a metro area network (MAN), the worldwide web (WWW), the Internet, implemented as wired and/or wireless networks, and any combinations thereof. The MTP 100 may be, but is not limited to, a tablet computer, a laptop computer, a smartphone, a cellular phone, a notebook computer, an intra-vehicle infotainment system, a smart television, a wearable computing device, and the like.

In certain configurations, the MTP 100 includes a plurality of hardware resources 120-1 through 120-m (hereinafter referred to individually as a hardware resource 120 and collectively as hardware resources 120, merely for simplicity purposes), a memory 140, and a processing unit 150. The hardware resources 120 may be used to send information from the MTP 100 and/or to receive information for the MTP 100. The hardware resources 120 may include, but are not limited to, internal hardware peripherals, external hardware peripherals, and so on. Exemplary hardware peripherals include, but are not limited to, a display screen, a speaker, a camera, a microphone, a touch-screen mechanism, a keyboard, a mouse, a secure key-store, an encryption hardware, a hard drive, a flash drive, other input/output devices, a cellular modem, a Wi-Fi, modem, and the like. An external peripheral may be connected to the MTP 100 via, for example, a USB connection or a network interface. Exemplary network interfaces include, but are not limited to, a high-definition multimedia interface (HDMI), Miracast protocol, and so on.

The hardware resources 120 may be allocated to groups based on user preferences, user inputs, and/or a policy of an operating system of the MTP 100. The group allocation may be made such that groups of hardware resources that are frequently used in conjunction are allocated to the same group. For example, a microphone and a camera may be grouped together.

The MTP 100 is configured with a plurality of personas 125-1 through 125-n (hereinafter referred to individually as a persona 125 and collectively as personas 125, merely for simplicity purposes), an agent 130, and a database 135 installed in the memory 140.

The MTP 100 is configured to execute the personas 125. Each persona 125 corresponds to a role or identity assumable by a user of the MTP 120 and to a unique execution environment. Each execution environment may be, but is not limited to, a virtual execution environment. Exemplary and non-limiting execution environments include operating systems, sandboxes, user-space containers, and hypervisors. Each persona may further include a unique set of metadata associated thereto.

In an embodiment, a persona is a user profile defined as part of an operating system supporting a multiple-user feature in the MTP 100. Such a user profile is maintained and monitored by the MTP's 100 operating system and allows the user to define, for each persona, a set of hardware resources accessible to a user of the profile. For example, one user profile may be set as a personal profile for the owner of the MTP 100 where all hardware resources are accessible without restrictions and another user profile may be set for an employee profile where only hardware resources needed for work-related purposes are accessible subject to restrictions on use.

Each persona may further be classified into different categories. Non-limiting and exemplary categories of personas may include, but are not limited to, personal, professional, financial, corporate, government, banking, digital wallet, privacy, and so on. Personas of the same type may be characterized as, for example, having access to a similar or the same set of hardware resources. The personas may be defined by users (e.g., owners of MTPs, an entity providing an MTP to its employee, and so on).

According to the disclosed embodiments, each of the personas 125 is set with a unique set of access control roles. The access control roles define permissions and/or restrictions of each persona 125 with respect to accessing any of the hardware resources 120. Thus, the access control roles (hereinafter referred to as “access controls”) determine whether each persona can access a particular hardware resource 120 as well as which limitations (if any) each persona is subject to during such access.

In an embodiment, any or all of the personas 125 may be associated with one or more of the hardware resources 120 and/or with one or more groups of the hardware resources 120. In a further embodiment, personas that are associated with a hardware resource are permitted by the access controls to access the hardware resource. Each persona 125 may be further allocated a portion of the memory 140 that maintains information regarding the groups of hardware resources 120 associated with the persona 125 as well as its respective unique set of access controls.

The MTP 100 is configured to execute at least on persona 125 (e.g., the persona 125-1) as a foreground persona with respect to a group of hardware resources. The access controls of the persona 125-1 are applied to the MTP 100 while the persona 125-1 is being executed in the foreground. The remaining personas 125 (e.g., the persona 125-n) may be either inactive or running as background personas. The background personas retain access to the hardware resources 120 subject to their respective access controls while in the background. Determination of which persona 125 to use as the foreground persona at any given time may be based on, but not limited to, user preferences, user inputs, and/or rules associated with each persona 125. A persona retaining access to a group of hardware resources is also executed in the foreground. Therefore, two or more personas can be executed in the foreground, each of which accessing a different group of hardware resources.

The access controls may be may be configured by information technology (IT) personnel, a security policy, a server external to the MTP 100, a user of the MTP 100, a policy of an operating system of the MTP 100, and so on. The access controls may define settings for each persona such as, but not limited to, restrictions on access and/or permissions to access any of the hardware resources 120.

Access restrictions may include, but are not limited to, limitations on functionality during access (e.g., only allowing the MTP 100 limited access to features of any of the hardware resources 120), prerequisites for accessing the hardware resources 120 (e.g., a required physical or network location of the MTP 100, a required time of access, etc.), and so on.

Permissions granted to a persona may include, but are not limited to, permissions of the personas 125 to access any of the hardware resources 120 for a limited period of time, permissions for one of the personas 125 to share access to any of the hardware resources 120 with any of the other personas 125, permissions of the persona 125 to have sole access to at least one hardware resource 120, prohibitions, and the like. A sole access is provided only to one persona and may be a private access or an exclusive access.

In an embodiment, any or all of the permissions may be contingent upon the persona 125 running in the foreground. Thus, a persona 125 running in the background may be denied permission to access the hardware resources 120 when the permission is contingent upon the persona running in the foreground.

In an embodiment, which access controls are applied to a persona 125 with respect to the hardware resources 120 can depend on whether the persona is running in the foreground or in the background. Thus, the settings can be changed when, for example, a persona in the foreground switches with a persona in the background. Switching from a foreground persona to a background persona may occur upon an explicit user request (e.g., the user selecting a personas to switch to) and/or upon occurrence of an event (e.g., an attempt by a background persona to access the hardware resources 120, a change in location of the MTP 100, and so on). As an example of an event-based switch, the MTP 100 may be a smartphone that receives a call via a background persona 125-n while the user is browsing the Internet via a foreground persona 125-1. Upon receiving such a call, the MTP 100 may switch the personas 125 such that the persona 125-n is running in the foreground and the persona 125-1 is running in the background. Switching between foreground personas is described further in U.S. patent application Ser. No. 14/465,169 filed on Aug. 21, 2014, entitled “SYSTEMS AND METHODS FOR SHARING AND SWITCHING BETWEEN PERSONAS ON MOBILE TECHNOLOGY PLATFORMS,” assigned to the common assignee, now pending, which is hereby incorporated by reference.

To this end, each persona 125 may be configured with a unique execution environment adjusted based on the access controls and whether the persona is running in the foreground or in the background. Upon detection of a switch, the permissions of each of the switched personas 125 may be modified accordingly such that the new access controls will be reflected in each respective execution environment. As an example, upon a switch, the status of the file descriptor associated with each one of the associated execution environments will be adjusted (i.e., active mode or non-active mode, active state or non-active state, etc.), and each execution environment will behave accordingly. As another example, upon a switch, a portion of the memory 140 related to each of the execution environments will be re-mapped so that each execution environment will behave according to its new mode.

The agent 130 is configured to manage access to the hardware resources 120 by the personas 125. The database 135 may include, but is not limited to, information related to the hardware resources 120. Such information may include, but is not limited to, types of transactions involving access to each hardware resources 120, a typical passage of time for a transaction, and so on.

In an embodiment, an access event is detected by the agent 130. The access event may be, but is not limited to, an attempt by a persona 125 to access a hardware resource 120, an attempt by a hardware resource 120 to deliver content to the personas 125, a switch from the foreground to the background by an accessing persona 125, and so on. Upon detecting the access attempt, the agent 130 is configured to determine whether one or more access controls of each persona 125 permits the persona 125 to access the hardware resources. For each persona 125 that is permitted to access the hardware resources, the agent 130 is configured to determine a type of access based on the access controls and the context of the access event (e.g., whether the persona 125 is in the foreground or in the background, whether multiple personas 125 would simultaneously have access to the hardware resources 120, and so on). Based on each determined type of access, the respective permitted persona 125 is granted the determined type of access to the hardware resources.

In an embodiment, the permission may be for a sole access to a hardware resource 120. As noted above, a sole access allows only one persona 125 to access the hardware resources at a time. The sole access may be a private access or an exclusive access. A private access allows the persona 125 to access the hardware resources regardless of whether the persona 125 is running in the foreground or in the background. An exclusive access allows the persona 125 to access the hardware resources only if the persona 125 is running in the foreground. The sole access may be further limited by the access controls. It should be noted that different personas 125 may be granted a sole access to a hardware resource 120.

In another embodiment, the permission may be for a shared access to the hardware resources 120. A shared access allows the plurality of personas 125 to concurrently access the hardware resources. In an embodiment, shared access may allow each of the plurality of personas to access the hardware resources regardless of whether that persona is running in the foreground or in the background. The shared access may be further limited by the access controls.

In yet another embodiment, the permission may be for a temporary access to the hardware resources. A temporary access may be granted to a persona 125 when a switch occurs and the persona 125 is restricted from accessing the hardware resources 120 while running in the background. The temporary access may be granted until a transaction is completed. The transaction begins when the persona 125 accesses the hardware resources and ends when a completion event occurs. In an embodiment, the completion event may be, but is not limited to, a passage of time, an interaction by the user of the MTP 100, a connection made between the MTP and an external device, a disconnection of the MTP from an external device, and so on. In a further embodiment, the time until the completion event occurs may be, but is not limited to, an average transaction time for such access. As a non-limiting example of granting temporary access, a smartphone accesses a receiver and a transmitter of the smartphone to make a phone call while a persona is running in the foreground. The access controls for the persona indicate that the persona may not access the receiver and transmitter while running in the background. Upon switching of the persona 125 to the background, the persona 125 may be granted temporary access until the call is completed.

In an embodiment, any of the personas 125 may be prohibited from accessing the hardware resources. If a persona that would be granted access is determined to be a prohibited persona, the prohibited persona is denied permission from accessing the hardware resources.

According to certain configurations, the agent 130 may be, but is not limited to, a software code installed in the memory unit 124 and executed by the processing unit 122. Alternatively, a script that is natively supported by an operating system of the MTP 120 may be used instead of the agent 130. The agent 130 may be executable code that is associated with the memory 124 and executed by the processing unit 122. In further configurations, the agent 130 may be any service running outside of or inside of a persona.

It should be noted that the above discussion is made with respect to one group of the hardware resources 120 associated with one foreground persona 125-1 and one background persona 125-n merely for simplicity purposes and without limitation on the disclosed embodiments. In various embodiments, multiple foreground personas may be utilized. The number of foreground personas are determined respective of the number of groups of hardware resources. That is, in an exemplary embodiment, each foreground persona may be associated with a group of hardware resources 120. The multiple foreground personas may be executed at the same time, where each persona can access only its designated hardware resources.

As an example of running multiple personas in the foreground, a persona that is responsible for recording videos may be run as a foreground persona concurrently with another persona for controlling the user interface. The video persona may be associated with a first group of hardware resources including a microphone and a camera, while the user interface persona may be associated with a second group of hardware resources including a touch screen and user buttons.

It should be further noted that the processing unit 150 may comprise or be a component of a processor (not shown) or an array of processors coupled to the memory unit 140. The memory unit 140 contains instructions that can be executed by the processing unit 150. The instructions, when executed by the processing unit 150, cause the processing unit 150 to perform the various functions described herein. The one or more processors may be implemented with any combination of general-purpose microprocessors, multi-core processors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

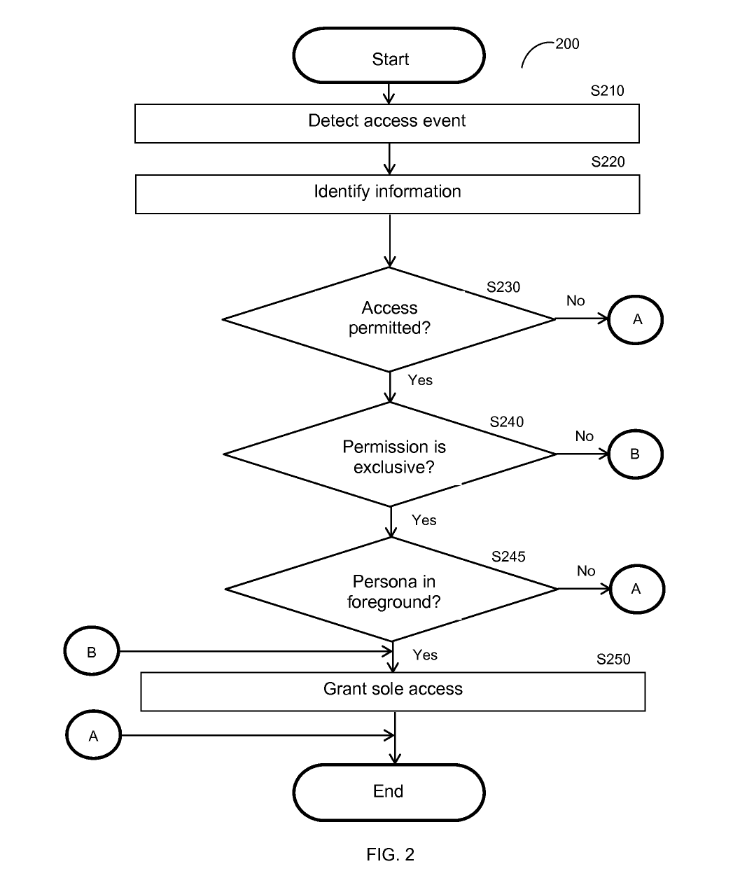

FIG. 2 is an exemplary and non-limiting flowchart 200 illustrating granting a sole access to hardware resources of a mobile technology platform (MTP). In an embodiment, the method may be performed by an agent (e.g., the agent 126) installed on the MTP.

In S210, an access event is detected. The access event may be, but is not limited to, an attempt by a persona to access hardware resources, an attempt by a hardware resource to deliver content to personas, a switch from the foreground to the background by an accessing persona, and so on. In an embodiment, the hardware resources may belong to a group of hardware resources.

In S220, information related to the hardware resources and/or personas designated in the access events are determined. In an embodiment, the information may be access controls associated with the persona. Access controls are described further herein above with respect to FIG. 1.

In S230, it is determined whether the persona has permission to access the hardware resources and, if so, execution continues with S240; otherwise, execution terminates. The determination may be based on the access controls. In an embodiment, determining whether the persona has permission to access the hardware resources further includes determining whether the permission is exclusive (i.e., requiring the persona to be running in the foreground) or private (i.e., available regardless of whether the persona is in the foreground or in the background). In an embodiment, if it is determined that the persona does not have permission to access the hardware resources, execution terminates. In another embodiment, it is checked whether the persona is prohibited from accessing the hardware resources. If the persona is prohibited, it may be determined that the persona does not have permission to access the hardware resources.

In S240, it is checked whether the permission is exclusive and, if so, execution continues with S245; otherwise, execution continues with S250. According to an embodiment, S240 further includes checking whether a transaction is in progress and, if so, execution continues with S250; otherwise, execution continues with S245. In S245, upon determining that the permission is for an exclusive access rather than a private access, it is checked whether the persona is running in the foreground and, if so, execution continues with S250; otherwise, execution terminates.

In S250, a sole access to the hardware resources is granted to the persona. In an embodiment, the granted sole access may be limited based on, e.g., access restrictions defined in the access controls. In another embodiment, if the granted access is an exclusive access, upon switching of the persona from the foreground to the background, execution may continue with S230.

As a non-limiting example, an attempt by a persona to access a hardware resource of an MTP is detected. An access control defining a permission for the persona to access the hardware resource is identified. The permission is contingent upon the persona being in the foreground of the MTP. It is determined that the permission is exclusive and that the persona is running in the foreground of the MTP. Based on the determination, a sole access to the hardware resource is granted to the persona.

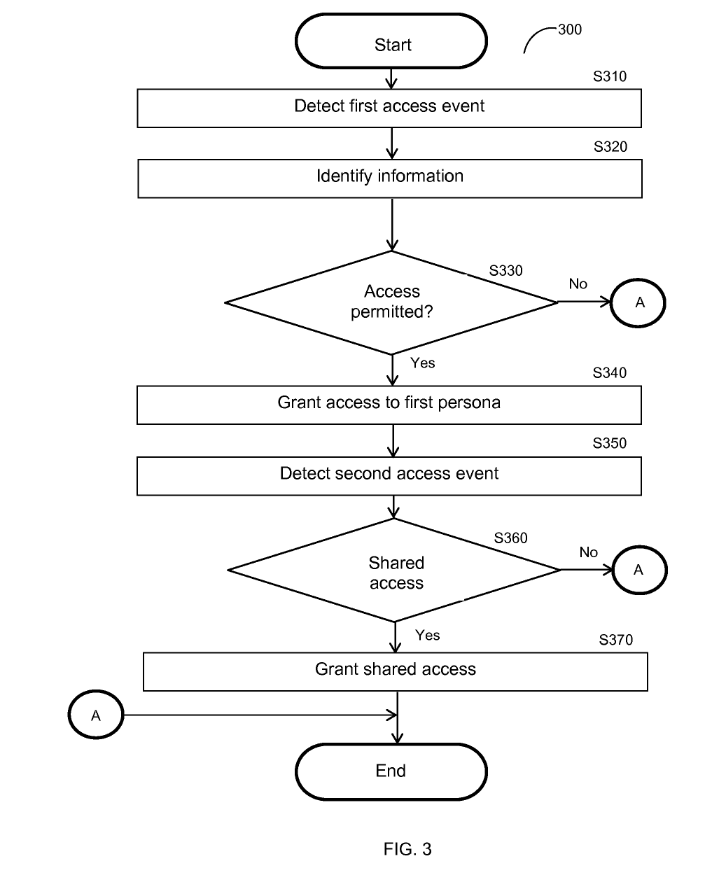

FIG. 3 is an exemplary and non-limiting flowchart 300 illustrating granting a shared access to one or more hardware resources to a plurality of personas of an MTP according to an embodiment.

In S310, a first access event relating to a first persona is detected. The access event may be, but is not limited to, an attempt by the first persona to access hardware resources, an attempt by a hardware resource to deliver content to the first persona, a switch from the foreground to the background by the first persona, and so on. In an embodiment, the hardware resources may belong to a group of hardware resources.

In S320, information related to the hardware resources, the first persona, and/or the group of hardware resources is identified. In an embodiment, the information may be access controls associated with the first persona. Access controls are described further herein above with respect to FIG. 1.

In S330, it is determined whether the first persona has permission to access the hardware resources. The determination may be based on the access controls. In an embodiment, if it is determined that the persona does not have permission to access the hardware resources, execution terminates. In another embodiment, it is checked whether the first persona is prohibited from accessing the hardware resources. If the first persona is prohibited, it may be determined that the persona does not have permission to access the hardware resources.

In S340, access to the hardware resources is granted to the first persona. In S350, a second access event relating to a second persona and to the hardware resources is detected. In S360, information related to any of the hardware resources, the first persona, the second persona, and/or the group of hardware resources is analyzed to determine whether the first persona and the second persona each has permission for shared access to the hardware resources. If shared access is permitted, execution continues with S370; otherwise, execution terminates. In an embodiment, the determination may further include determining whether the shared access permission for each persona is contingent upon that persona running in the foreground and, if so, granting the shared access only if the appropriate persona is running in the foreground.

In S370, a shared access is granted to each of the first persona and the second persona.

It should be noted that, in an embodiment, the shared access may be granted regardless of whether each of the first persona and the second persona is running in the foreground or in the background.

As a non-limiting example, an attempt by a work persona to access a USB port of an MTP is detected. An access control defining a first permission for the work persona to share access to the USB port is identified. The first permission is not contingent upon the work persona being in the foreground of the MTP. Access to the USB port is granted to the work persona. A second attempt by a home persona to access the USB port is detected. An access control defining a second permission for the home persona to share access to the USB port is identified. The second permission is also not contingent upon the home persona being in the foreground. Based on the determined shared permissions, shared access to the USB port is granted to the work and home personas, thereby allowing the personas to concurrently access the USB port.

It should be noted that a first persona and a second persona are described herein above with respect to FIG. 3 merely to distinguish two accessing personas and without any limitation on the various disclosed embodiments.

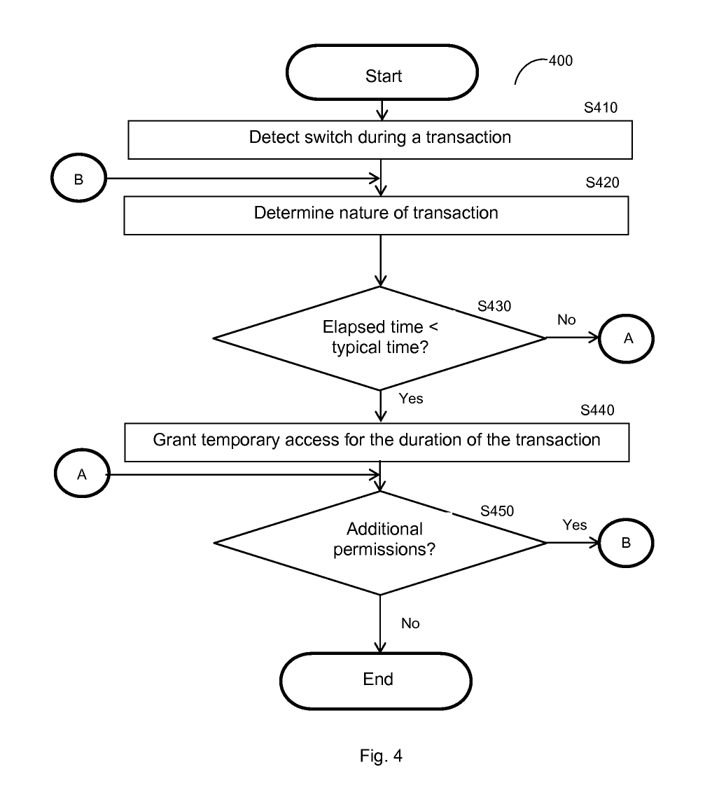

FIG. 4 is an exemplary and non-limiting flowchart 400 illustrating granting a temporary access to one or more hardware resources to a persona of an MTP according to an embodiment. In an embodiment, access controls of the persona would deny the persona permission to access the hardware resources when the persona is in the background.

In S410, a switch access event is detected while the persona (e.g., the persona 125-1) is in the foreground of the MTP and during a transaction. The transaction is a period of continuous access to a hardware resource by the persona. The transaction begins when the persona 125 accesses the hardware resource and ends when a completion event occurs. In an embodiment, the completion event may be, but is not limited to, a passage of time, an interaction by the user of the MTP, a connection made between the MTP and an external device, a disconnection of the MTP from an external device, and so on. In a further embodiment, the amount of time to be passed during a transaction may be, but is not limited to, an average transaction time for such access.

In S420, information related to the hardware resource is analyzed to determine a nature of the transaction. The nature of the transaction may include, but is not limited to, a type of the transaction, an elapsed time of the transaction, a typical time of the transaction or type of transaction, a completion event for the transaction, and so on. Exemplary types of transactions may be, but are not limited to, a phone call, a web browsing session, a download of data from a network, a connection to an external hardware resource, and so on. The information related to the hardware resource may be stored in a database (e.g., the database 135) of the MTP.

In optional S430, it may be determined whether the transaction is still in progress and, if so, execution continues with S440; otherwise, execution continues with S450. In a further embodiment, the transaction may still be in progress if the elapsed time of the transaction is less than a typical time of the transaction. The typical time of a transaction may be stored in, e.g., the database.

In S440, a temporary access to the hardware resource is granted to the persona for the duration of the transaction (i.e., until the completion event occurs). The temporary access may be a private access to the hardware resource for a predefined period of time or until a predefined completion event occurs. In S450, it is checked whether the persona had permission to access additional hardware resources during the switch and, if so, execution continues with S420; otherwise, execution terminates.

As a non-limiting example, a switch of a persona from the foreground of an MTP to the background is detected while the persona is conducting a phone call via a hardware resource. The nature of the transaction is determined to be a phone call that is completed when the call ends (e.g., hanging up the phone). A temporary access is granted to the persona until the call ends.

As another non-limiting example, a switch of a persona from the foreground of an MTP to the background is detected while the persona is accessing a network via a hardware resource. A nature of the transaction indicates that the transaction is web browsing, that the transaction is completed when a typical time of 10 minutes for web browsing has passed, and that 3 minutes of web browsing have already elapsed. The persona is granted a temporary access to the hardware resource for the remaining 7 minutes of the transaction.

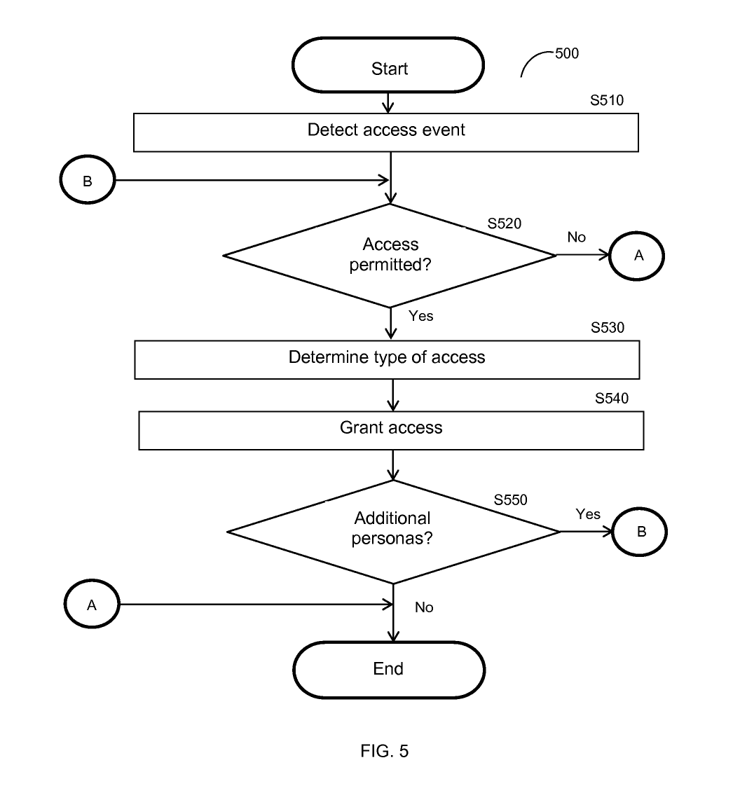

FIG. 5 is an exemplary and non-limiting flowchart 500 illustrating a method for managing access of personas to hardware resources according to an embodiment.

In S510, an access event is detected respective of a persona. The various type of access events are described further herein above.

In S520, upon detecting the access event, it is determined whether access controls of the persona permits the persona to access the hardware resources and, if so, execution continues with S530; otherwise, execution terminates. In an embodiment, S520 may further include determining whether the permission is contingent upon the persona running in the foreground and determining whether the persona is currently in the foreground. In a further embodiment, if the persona is not currently in the foreground when the permission is contingent on the persona being in the foreground, it may be determined that the persona is not permitted to access the hardware resources.

In S530, upon determining that the persona is permitted to access the hardware resources, a type of access is determined based on the context of the access event. The context of the access event may be based on, but not limited to, a type of the access event (e.g., a switch access event may result in a temporary access), whether additional personas are currently accessing the hardware resources, and so on.

In S540, based on the determined type of access, the persona is granted access to the hardware resources. The various embodiments for granting a persona access to hardware resources respective of the determined access type are described further herein above. In S550, it is determined whether the access event involved additional personas and, if so, execution continues with S520; otherwise, execution terminates.

According to certain exemplary and non-limiting embodiments, all the processes described with respect to FIGS. 2-5 can be performed and/or controlled by the agent 130. In other embodiments, these processes can be performed and/or controlled by a processing unit of the MTP 100.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for managing access to hardware resources on a multiple-persona mobile technology platform (MTP), comprising:
detecting an access event between at least one persona and at least one hardware resource of the MTP;
identifying at least one access control of the at least one persona;
determining for each persona, based on the at least one access control, whether the persona has permission to access the at least one hardware resource; and
upon determining that at least one permitted persona has permission to access the at least one hardware resource, granting the access to the at least one permitted persona.

2. The method of claim 1, wherein each persona in the MTP is a user profile defined as part of an operating system supporting a multiple-user feature of the MTP.

3. The method of claim 1, wherein each persona in the MTP is defined with a unique set of user preferences associated with a respective persona.

4. The method of claim 1, further comprising:
determining, for each access control, whether a grant of access is contingent upon the at least one persona running at a foreground of the MTP;
upon determining that at least one grant of access is contingent upon the at least one persona being in the foreground of the MTP, determining whether the at least one persona is in the foreground of the MTP; and
upon determining that the at least one persona is in the foreground of the MTP, granting the at least one persona access to the at least one hardware resource.

5. The method of claim 1, wherein granting the access to the at least one permitted persona further comprises:
determining a type of access to grant to the at least one persona based on the at least one access control, wherein the type of access is determined based on the at least one access control and a context of the access event, wherein the type of access is any of: a private access, an exclusive access, a shared access, and a temporary access.

6. The method of claim 5, further comprising:
upon determining that the type of access is an exclusive access contingent upon the persona being in the foreground, determining whether the persona is in the foreground; and
upon determining that the persona is in the foreground, granting the exclusive access.

7. The method of claim 5, further comprising:
detecting a second access event between at least one other persona and the at least one hardware resource;
identifying at least one access control of the at least one other persona;
determining, for each persona based on the respective access control of the persona, whether the persona has permission to share access to the at least one hardware resource; and
upon determining that each persona has permission to share access to the at least one hardware resource, granting the shared access to the at least one other persona and to the at least one other persona.

8. The method of claim 5, wherein the access event is a switch detected during a transaction, further comprising:
determining a nature of the transaction, wherein the nature includes a completion event, wherein the access granted to the permitted persona terminates upon occurrence of the completion event.

9. The method of claim 1, wherein the at least one access control prohibits granting a prohibited persona access to a forbidden hardware resource.

10. A non-transitory computer readable medium having stored thereon instructions for causing one or more processing units to execute the method according to claim 1.

11. A multiple-persona mobile technology platform (MTP) for managing access to hardware resources on multiple-persona mobile technology platforms, comprising:
a processing unit; and
a memory, the memory containing instructions that, when executed by the processing unit, configure the system to:
detect an access event between at least one persona and at least one hardware resource of the MTP;
identify at least one access control of the at least one persona;
determine for each persona, based on the at least one access control, whether the persona has permission to access the at least one hardware resource; and
upon determining that at least one permitted persona has permission to access the at least one hardware resource, grant the access to the at least one permitted persona.

12. The MTP of claim 11, wherein each persona in the MTP is a user profile defined as part of an operating system supporting a multiple-user feature of the MTP.

13. The MTP of claim 11, wherein each persona in the MTP is defined with a unique set of user preferences associated with a respective persona.

14. The MTP of claim 11, wherein the MTP is further configured to:
determine, for each access control, whether a grant of access is contingent upon the at least one persona being in a foreground of the MTP;
upon determining that at least one grant of access is contingent upon the at least one persona being in the foreground of the MTP, determine whether the at least one persona is in the foreground of the MTP; and
upon determining that the at least one persona is in the foreground of the MTP, grant the at least one persona access to the at least one hardware resource.

15. The MTP of claim 11, wherein the system is further configured to:
determine a type of access to grant to the at least one persona based on the at least one access control, wherein the type of access is determined based on the at least one access control and a context of the access event, wherein the type of access is any of: a private access, an exclusive access, a shared access, and a temporary access.

16. The MTP of claim 15, wherein the MTP is further configured to:
upon determining that the type of access is an exclusive access contingent upon the persona being in the foreground, determine whether the persona is in the foreground; and
upon determining that the persona is in the foreground, grant the exclusive access.

17. The MTP of claim 15, wherein the MTP is further configured to:
detect a second access event between at least one other persona and the at least one hardware resource;
identify at least one access control of the at least one other persona;
determine, for each persona based on the respective access control of the persona, whether the persona has permission to share access to the at least one hardware resource; and
upon determining that each persona has permission to share access to the at least one hardware resource, grant the shared access to the at least one persona and to the at least one other persona.

18. The MTP of claim 15, wherein the access event is a switch detected during a transaction, wherein the MTP is further configured to:
determine a nature of the transaction, wherein the nature includes a completion event, wherein the access granted to the permitted persona terminates upon occurrence of the completion event.

19. The MTP of claim 11, wherein the at least one access control prohibits granting a prohibited persona access to a forbidden hardware resource.

20. The MTP of claim 11, wherein the MTP is any one of: a cellular phone, a smartphone, a tablet device, a notebook computer, a laptop, an intra-vehicle infotainment system (IVI), and a wearable computing device.
